(19) United States
(12) Patent Application Publication
(10) Pub. No.: US 2013/0059117 A1
(43) Pub. Date: Mar. 7, 2013

(54) Display Screen Protecting Film with Reflective Graphical Elements

(71) Applicant: John Hill, Kissimmee, FL (US)

(72) Inventor: John Hill, Kissimmee, FL (US)

(21) Appl. No.: 13/656,722

(22) Filed: Oct. 21, 2012

(51) Int. Cl. B32B 3/24; C09J 7/02

(52) U.S. Cl. 428/138; 428/137

(57) ABSTRACT

The present invention provides a display screen protecting film for use on cell phones, smart phones, tablets, and computer or television display panels that incorporates vanishing graphical elements. Specifically, the protective films of the present invention are constructed with reflective text and images embedded in or on the film such that the embedded text and images appear under ambient light and vanish when the underlying screen is illuminated to display an image.

### CROSS-REFERENCE TO RELATED APPLICATIONS

This application takes benefit of U.S. Provisional Appl. No. 61/742,638 filed Aug. 16, 2012 which is incorporated in its entirety by reference.

### FIELD OF THE INVENTION

The present invention deals generally with a display screen protecting film for use on cell phones, smart phones, tablets, and computer or television display panels that incorporates vanishing graphical elements. Specifically, the protective films of the present invention are constructed with reflective text and images embedded in or on the film such that the embedded text and images appear under ambient light and vanish when the underlying screen is illuminated to display an image. The embedded images may be monochromatic or multichromatic.

### BACKGROUND OF THE INVENTION

Numerous items today contain flat panel displays. Such flat panel displays include LCDs, LEDs, and plasma displays. Unlike old fashioned cathode-ray displays which featured a stout, scratch resistant glass front panel, most flat panel displays are constructed of plastic or very thin glass, or some combination of both. The former scratches easily and the latter can be broken if not carefully handled. As a result, various kinds of screen protectors have been created. Usually constructed of thin transparent plastic material, these screen protectors are pre-cut to fit various devices and adhere to the display electrostatically or by means of a low-tack adhesive. These screen protectors come in a wide variety of shapes and appearances. Most are largely or completely transparent. Others have printing on that part of the screen protector that is to be placed over the “dead area” of the device—i.e. the areas of the device that surround the display. Others are available featuring a “mirrored” surface. These screen protectors are made using a layer of very thinly deposited reflective metallic particles. As a result, when the display is not illuminated the screen protector appears to be a mirrored surface. When the display is on, however, sufficient light passes through the screen protector so that the image generated by the display can be seen by the user. Such mirrored films may be created in any shade of gray or in a variety of colors ranging from red to silver to gold to pink to blue to violet.

### BRIEF DESCRIPTION OF THE INVENTION

The present invention uses at least one of the aforementioned reflective metal particles applied in a pattern to create a graphical element comprising images, graphics, text, and/or logos embedded within, or on top of, the screen protector such that when the device is off and the display is not illuminated the graphical element is visible but when the screen is illuminated the graphical element largely disappears. In this embodiment, the invention is comprised of a transparent polyester base film on which the graphical element is comprised of at least one thin layer of reflective metallic particles. The thinly coated areas comprising the graphical element necessarily obscure less than 100% of the area of the screen protector covering the illuminated display of the device. The graphical element is preferably comprised of at least two kinds of metallic particles or the same kind of metallic particles applied in at different densities. When the graphical element is comprised of two different metallic particles, different colors may be obtained. For example, the image of a gold star superimposed on a silver filled circle may be created. When a protective film featuring these graphical elements is applied to a display panel, the image would appear as a sharply reflective gold star superimposed on a sharply reflective silver filled circle when the display is not illuminated and would largely vanish when the display is illuminated. Similarly, when different densities of the same metallic particles are used, multiple shades of a single color may be used to create the graphical element. For example, an image may be created in which a star is rendered in a more densely applied layer of silver reflective particles and a surrounding circle is rendered in a less densely applied layer of silver reflective particles. When a protective film featuring these graphical elements is applied to a display panel, the image would appear as a sharply reflective silver star superimposed on a less sharply reflective pewter filled circle when the display is not illuminated and would largely vanish when the display is illuminated. Depending on the nature of the polyester base film, it may innately adhere to the display electrostatically or a low tack adhesive may be applied. In all cases, the side of the polyester base film on which the graphical element is rendered may be optionally covered with a transparent protective layer.

### BRIEF DESCRIPTION OF THE DRAWINGS

FIG. 1 is a top view of a multi-toned display screen protective film with monochrome reflective graphical elements.

FIG. 2 is a top view of a display screen protective film with multi-colored reflective graphical elements.

### DETAILED DESCRIPTION OF THE INVENTION

Traditional mirrored film is made by coating a transparent substrate polymer film such as, without limitation, polyester terephthalate (PET), polyester napathalate (PEN), Kapton®, Ultem®, cellulose tri-acetate (TAC), and cyclo-olefin polymer (COP) with a thin coating of reflective substances. Such substances include various metals and their metal alloys and metal oxides, including, without limitation: aluminum, copper, gold, indium, nichrome, palladium, platinum, silicon, silver, stainless steel, tin, tungsten, vanadium, and zirconium. Ordinarily the polymer film is coated by means of conventional vacuum or sputter deposition in which the polymer film substrate is exposed to an ionized vapor of the selected metal and the metal particles physically bond to the surface of the polymer film substrate. By mixing more than one material or adding trace amounts of a various gasses during the sputtering process, a wide range of colors may be achieved. For example, Al₂O₃ sputtered in combination with trace amounts of V₂O₃ provides a blue film. Al₂O₃ sputtered with a trace amount of NiO provides a yellow film. TiN is one of the oldest sputtered coatings, providing the familiar gold color of modern architectural windows. (TiAl)N thin film coatings are created by sputtering Ti and Al with varying amounts of N. The concentration of N in the sputter chamber controls the vibrancy of the resulting blue color.

As the length of time the film is exposed to the ionized vapor is increased, the thickness and density, and thus the reflectivity and opacity, of the metalized polymer film also increases. At the limit, 100% coverage of the surface area of the film is achieved and the surface is brilliantly reflective yet completely opaque. For example, one such metallized polymer film featuring aluminum, gold, silver, etc. applied by means of magnetron sputtering is described in U.S. Pat. No. 5,631,066. In many cases however, brilliant reflectivity coupled with complete opacity is less than desirable. For example, for reflective window film complete opacity is usually undesirable. As a result, by limiting the amount of time the polymer film is exposed to the metal vapor, a very thin coating may be achieved that visually has a mirrored surface, but has a thickness and density low enough that a substantial portion of the light that impinges on the polymer film passes through unobstructed.

Such polymer films are commonly available with a visible light transmission (VLT) factor ranging between 0% and 95%. The thickness of the reflective layer required to achieve VLT factors in this range is dependent on the plated material, but for aluminum the thickness ranges from about 40 nm to less than 1 nm. To achieve an obvious mirrored effect, a slightly thicker film of metal is required, e.g. for ˜30% reflectivity and a ˜60% VLT factor an aluminum film must be at least 1.5 nm thick. Since gold and silver are naturally more reflective, thinner films achieve the same mirrored effect. In any case, designs featuring thicker films with VLT factors less than ˜50% are impractical because they attenuate the light emitted by the flat panel display too such a degree that they deleteriously affect the user's ability to perceive the images generated by the display.

Numerous methods are well known in the art whereby such metal plated polymer films may be further processed to create intricate patterns. U.S. Pat. 4,440,801 describes numerous techniques available to do this. For example, a metal coated polymer film may be coated with a resist layer which is later exposed to light defining the pattern of the metal to be left on the polymer film. After the unwanted metal is removed, only the desired pattern remains. Before the remaining resist layer is removed, such a polymer film may be re-subjected to an additional conventional vacuum or sputter deposition operation this time with a different metal and treated with a second resist layer defining an additional part of the pattern. After the unwanted second metal and the exposed resist layers are removed only the desired two color design remains. This process can be repeated any number of times to create multicolored mirrored images on film.

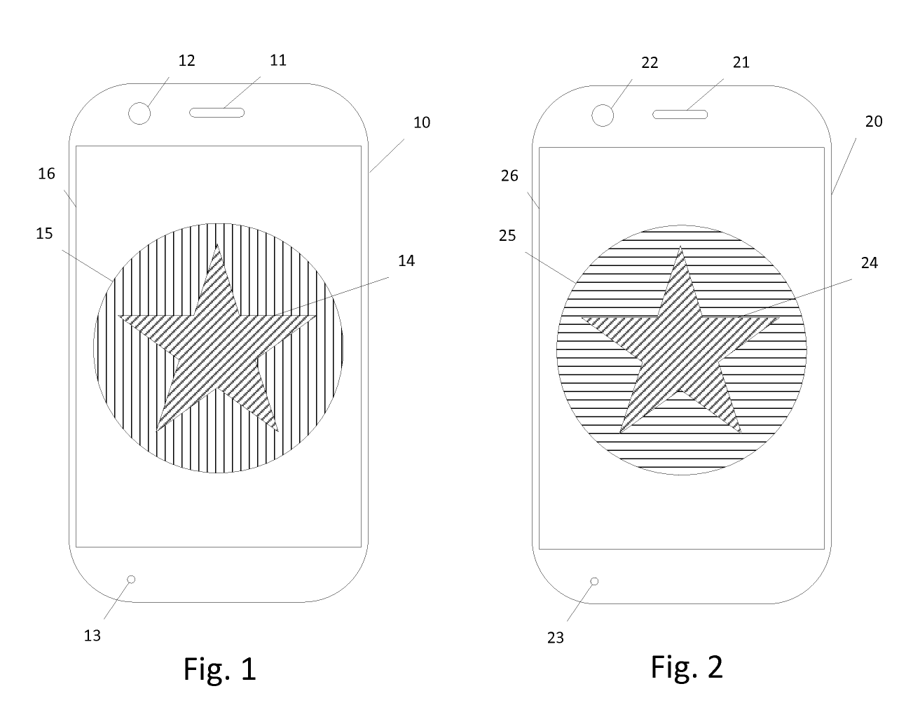

Turning now to FIG. 1, using this technique a sharply reflective silver mirrored star on a darker, less sharply reflective silver filled circle may be realized. For example, if a polymer film screen protector 10 with various perforations exposing an earpiece aperture 11, a camera aperture 12, and a microphone aperture 13 is: 1) Subjected to a first conventional vacuum or sputter deposition operation to create a brightly reflective 1.5 nm Al layer; 2) Centrally coated with resist in the form of a star 14; 3) Treated to remove the excess aluminum; 4) Re-subjected to a shorter second conventional vacuum or sputter deposition operation to create a 1.0 nm Al layer; 5) Coated a second time with resist in the form of a circle 15 cutout to closely surround star 14; 6) Treated again to remove the excess aluminum; and, 7) Cleaned to remove the two resist layers. In this example, the star 14 will be more sharply reflective silver (˜30% reflectivity with a ˜60% VLT) while the filled circle 15 upon which it is superimposed will be a darker, less sharply reflective pewter (˜20% reflectivity with a ˜70% VLT) when display 16 is not illuminated. When display 16 is illuminated the design largely disappears from view.

Turning now to FIG. 2, using this technique a sharply reflective silver mirrored star on a sharply reflective gold filled circle may also be realized. Since gold is more reflective than aluminum, a slightly thinner layer of gold has roughly the same reflectivity and VLT as an equally thin layer of aluminum. For example, if a polymer film screen protector 20 with various perforations exposing an earpiece aperture 21, a camera aperture 22, and a microphone aperture 23 is: 1) Subjected to a first conventional vacuum or sputter deposition operation to create a brightly reflective 1.5 nm Al layer; 2) Centrally coated with resist in the form of a star 24; 3) Treated to remove the excess aluminum; 4) Re-subjected to a shorter second conventional vacuum or sputter deposition operation using Au to create a 1.25 nm layer of gold; 5) Coated a second time with resist in the form of a circle 25 cutout to closely surround star 24; 6) Treated to remove the excess gold; and, 7) Cleaned to remove the two resist layers. In this example, the star 24 will be sharply reflective silver (˜30% reflectivity with a ˜60% VLT) while the filled circle 25 upon which it is superimposed will be a sharply reflective gold (˜30% reflectivity with a ˜60% VLT) when display 26 is not illuminated. When display 26 is illuminated the design largely disappears from view.

Conventional vapor and sputter deposition are not the only methods by which polymer films with thin plated areas may be realized. Numerous methods of electroless plating are also well known in the art. One such method is described in U.S. Pat. 3,436,468 wherein the area designated for plating is exposed to an electron beam. The electron beam chemically alters the surface of the polymer film so that metals such as nickel and copper may be electrolessly plated on the surface. If the excess metal is removed after covering the desired area of the newly plated surface with a resist impervious to subsequent overplatings, the process can be repeated multiple times to form an image composed of multiple plated areas each plated in a different material featuring a different color and intensity. U.S. Pat. 4,042,730 describes another technique, wherein the polymer film is cleaned with an organic cleaner to remove contaminants and etched to provide some roughness for the deposition of a sensitizing and activating solution. These solutions may be applied to create a complex pattern. The polymer film is then subjected to a conventional electroless plating bath. As above, if the excess metal is removed after covering the desired area of the newly plated surface with a resist impervious to subsequent overplatings, the above process may be repeated multiple times to create a complex design. U.S. Pat. No. 4,268,536 is but one among many describing alternative methods of achieving similar effects.

What is claimed is:

1. A screen protector for covering the front panel of an electronic device wherein said front panel of said electronic device incorporates an illuminated flat panel display said screen protector being a first thin transparent plastic layer, further comprising:
a. at least one mirrored pattern representing a graphical element, said mirrored pattern covering less than 100% of the surface area of one side of said screen protector overlying said flat panel display and said mirrored pattern having a visible light transmission factor no less than about 50%;
b. a plurality of through holes corresponding to the location of a camera lens, speaker aperture, and microphone aperture, if any.

2. A screen protector of claim 1, further comprising a second thin transparent layer coextensive in size to said first thin transparent plastic layer applied over said first thin transparent plastic layer sandwiching said graphical element between said first thin transparent plastic layer and said second thin transparent plastic layer.

3. A screen protector of claim 1, further comprising a low tack adhesive evenly applied to said first thin transparent layer on the side opposite said graphical element.

4. A screen protector of claim 2, further comprising a low tack adhesive evenly applied to said second thin transparent layer on the side opposite said graphical element.
